(19) United States
(12) Patent Application Publication
(10) Pub. No.: US 2010/0057332 A1
(43) Pub. Date: Mar. 4, 2010

(54) ENGINE CONTROL SYSTEM FOR VEHICLE

(75) Inventors: Kunio KATOH, Nagoya-city (JP); Kentaro Teshima, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/550,820

(22) Filed: Aug. 31, 2009

(30) Foreign Application Priority Data
Sep. 4, 2008 (JP) 2008-227533

(51) Int. Cl. G06F 19/00

(52) U.S. Cl. 701/113

(57) ABSTRACT

An engine control system checks whether communication is established between a mobile unit carried by a driver and a shift lever, a brake pedal and a steering wheel through a human body of the driver. If the communication is not established, the engine control system prohibits an automatic start of an engine even when a predetermined manipulation required for starting the engine is detected. As a result, the engine is prohibited from being started automatically against the driver's intention.

### CROSS REFERENCE TO RELATED APPLICATION

The present application is based on and incorporates herein by reference Japanese patent application No. 2008-227533 filed on Sep. 4, 2008.

### FIELD OF THE INVENTION

The present invention relates to an engine control system for a vehicle.

### BACKGROUND OF THE INVENTION

It is known that, in some conventional systems, a user carrying a mobile unit (electronic key) is allowed to start and stop an engine by only turning on and off a push button-type engine switch without inserting an ignition key into a key cylinder.

It is also proposed in recent years that a user is allowed to start and stop an engine without turning on and off a push button-type engine switch to further enhance convenience of a driver in respect of starting and stopping an engine. For example, patent document 1 discloses a system, which checks a code of a mobile unit when a predetermined manipulation normally performed by a driver in starting a vehicle is detected, and starts an engine automatically when a code check result indicates that the code is proper indicating that the mobile unit is an authorized one. Further, patent document 1 discloses a system, which checks a code of a mobile unit when a manipulation normally performed by a driver in a parking vehicle is detected, and starts an engine automatically when a code check result indicates that the code is proper.

[Patent document 1] JP 2003-26930A corresponding to US 2003/0135321
[Patent document 2] JP 10-228524A corresponding to U.S. Pat. No. 5,796,827

However, according to the system disclosed in patent document 1, it is not possible to check whether the required predetermined manipulation has been actually performed by the driver or accidentally performed by a passenger other than the driver. In this instance, even if a part of the required predetermined manipulation has been performed accidentally by the passenger other than the driver, the engine will be automatically started or stopped against the driver's intention.

### SUMMARY OF THE INVENTION

It is therefore an object of the present invention to provide an engine control system, which enhances convenience of a driver while ensuring safety of a vehicle.

According to the present invention, an engine control system for a vehicle includes a mobile unit carried by a driver, a manipulation device mounted in a vehicle and a control unit mounted in the vehicle. The mobile unit is carried by a driver and includes a mobile-side human communicator for transmitting and receiving data by human body communication using a body of the driver. The manipulation device is normally operable by the driver to start or stop the engine. The manipulation device includes a vehicle-side human communicator for transmitting and receiving data by the human body communication. The control unit is configured to detect the predetermined manipulation, to check whether the predetermined manipulation is detected, to check whether data is transmitted and received between the mobile unit and the manipulation device by the human body communication, and to automatically start or stop the engine based on an operation check result of the operation check part indicating detection of the predetermined manipulation and data communication between the mobile unit and the manipulation device by the human body communication.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing schematically an engine control system for a vehicle according to an embodiment of the present invention;

FIG. 2 is a block diagram showing schematically a mobile-side human communicator in the embodiment;

FIG. 3 is a block diagram showing schematically a vehicle-side human communicator in the embodiment;

FIG. 4 is a schematic view showing human body communication in the embodiment; and

FIGS. 5A and 5B are flowcharts showing control processing for automatically starting an engine in the embodiment.

### DETAILED DESCRIPTION OF THE PREFERRED EMBODIMENT

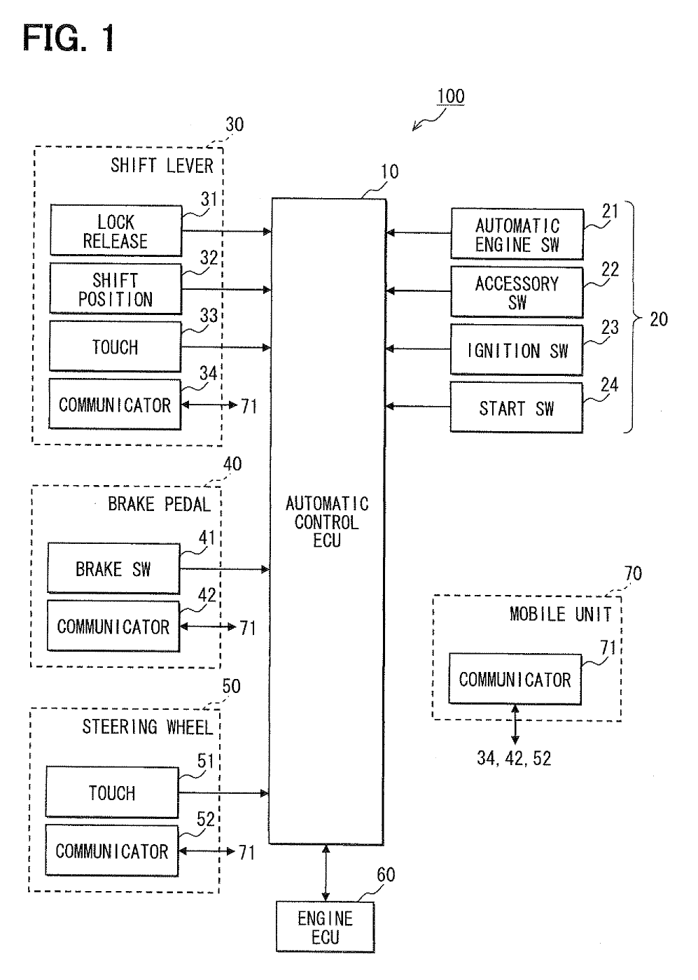

The present invention will be described in detail with reference to an embodiment of an engine control system 100 for a vehicle shown in FIG. 1.

The engine control system 100 includes an automatic control ECU 10, a vehicle ignition switch device 20, a shift lever 30, a brake pedal 40, a steering wheel 50, an engine ECU 60 and a mobile unit 70. The automatic control ECU 10, the vehicle ignition switch device 20, the shift lever 30, the brake pedal 40, the steering wheel 50 and the engine ECU 60 are mounted in a vehicle.

The automatic control ECU 10 is an electronic control unit, which performs automatic starting and/or automatic stopping of an engine in a vehicle equipped with an automatic transmission. The automatic control ECU 10 is configured with a CPU, a ROM, a RAM, an A/D converter, an input/output interface (I/O) and a bus line, which are not shown. The CPU is for controlling a variety of devices. The ROM is for storing a variety of numerical constants and programs. The RAM is for storing numerical values and flags produced in the process of calculations in predetermined storage areas. The A/D converter is for converting analog input signals into corresponding digital signals. The input/output interface is for inputting and outputting a variety of digital signals. The bus line is for connecting these units one another. The processing described below is performed based on a control program written in the ROM.

The vehicle ignition switch device 20 includes an automatic engine switch (SW) 21, an accessory switch 22, an ignition switch 23 and a start switch 24. The accessory switch 22, the ignition switch 23 and the start switch 24 are conventional switches. When the automatic engine switch 21 is turned on, the automatic control ECU 10 performs the automatic engine start control and/or automatic engine stop control. The ignition switch device 20 is, for example, a rotary switch, which selects the automatic engine switch 21, the accessory switch 22, the ignition switch 23 and the start switch 24 by its rotary motion.

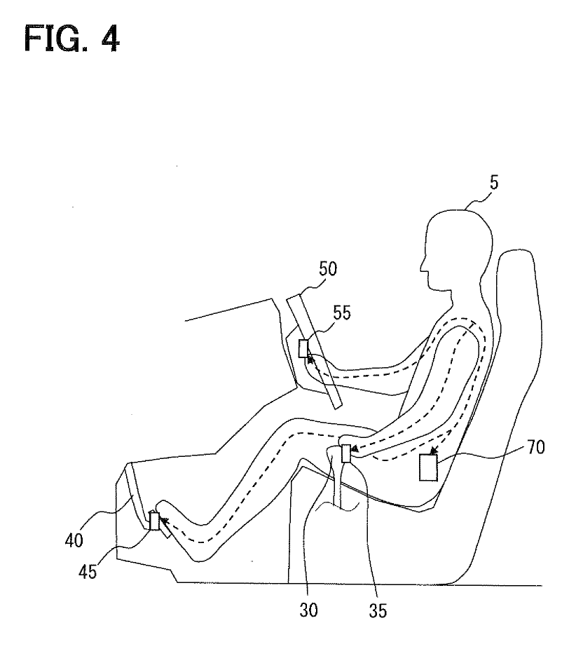

The shift lever 30 is operated by a driver 5 (FIG. 4) to change engagement of gears of the transmission, and includes a shift-lock release button 31, a shift position sensor 32, a touch sensor 33 and a vehicle-side human communicator 34. The shift-lock release button 31 is for releasing a shift lock of a shift-lock mechanism, which disables shifting of the shift lever 30 from the parking range (P). The shift position sensor 32 detects at which the shift lever 30 is manipulated among the parking range (P), the reverse range (R), the neutral range (N), the drive range (D), the second range (2) and the low range (L). The touch sensor 33 is for detecting whether the shift lever 30 is held or touched. The touch sensor 33 is, for example, a pressure-sensitive element. The vehicle-side human communicator 34 is for transmitting and receiving data by human body communication, which performs communication using a human body as a signal propagation path as disclosed in patent document 2. In this embodiment, of a current system or an electric field system, human body communication is performed according to the electric field system. Further, data signals are transmitted and received by the human body communication in pulse signals of rectangular waveform, for example.

The brake pedal 40 is operated by the driver 5 to brake a vehicle, and includes a brake switch 41 and a vehicle-side human communicator 42. The brake switch 41 is for detecting braking manipulation on the brake pedal 40. The vehicle-side human communicator 42 is for transmitting and receiving data by human body communication.

The steering wheel 50 is for steering a travel direction of a vehicle, and includes a touch sensor 51 and a vehicle-side human communicator 52. The touch sensor 51 is for detecting whether the steering wheel 50 is held or touched. The touch sensor 51 is, for example, a pressure-sensitive element provided on the steering wheel 50. The vehicle-side human communicator 52 is for transmitting and receiving data by human body communication.

The engine ECU 60 is an electronic control unit, which performs engine control such as fuel control, ignition control and the like. Like the automatic control ECU 10, the engine ECU 60 is also configured with a CPU, a ROM, a RAM, an A/D converter, an input/output interface (I/O) and a bus line, which are not shown. The CPU is for controlling a variety of devices. The ROM is for storing a variety of numerical constants and programs. The RAM is for storing numerical values and flags produced in the process of calculations in predetermined storage areas. The A/D converter is for converting analog input signals into corresponding digital signals. The input/output interface is for inputting and outputting a variety of digital signals. The bus line is for connecting these units one another. The processing described below is performed based on a control program written in the ROM. The engine ECU 60 is configured to start and stop the engine under control of the automatic control ECU 10.

The mobile unit 70 is a mobile device, which is carried by the driver 5, and includes a mobile-side human communicator 71. The mobile-side human communicator 71 is for transmitting and receiving data by human body communication.

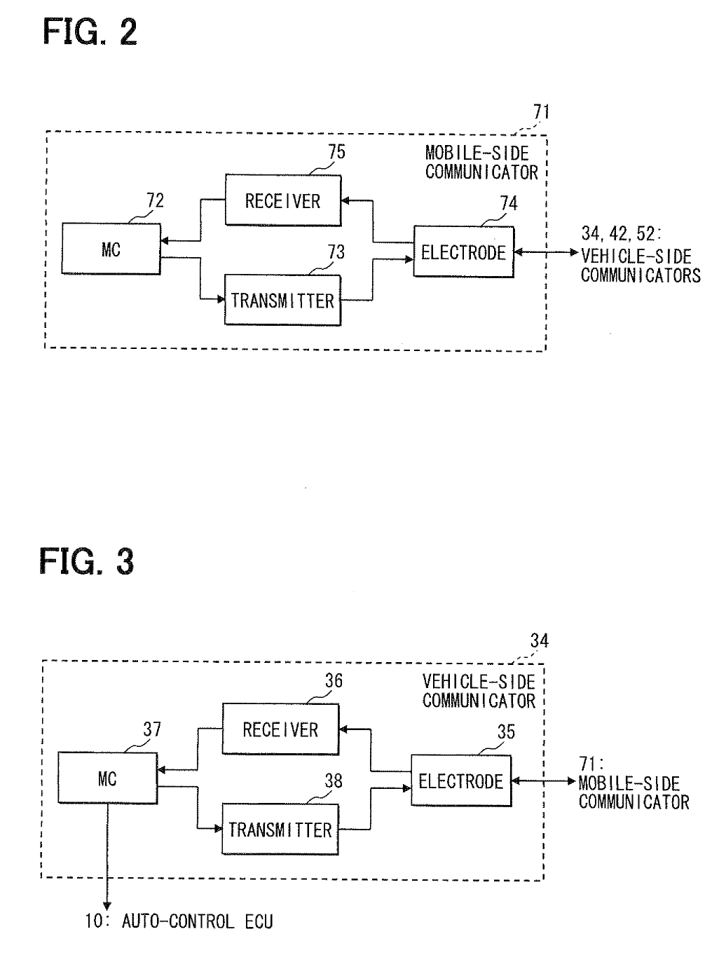

The mobile-side communicator 71 and the vehicle-side communicator 34 are configured as shown in FIGS. 2 and 3, respectively. The vehicle-side human communicators 42 and 52 are configured in the similar manner as the vehicle-side human communicator 34 shown in FIG. 3.

The mobile-side human communicator 71 includes, as shown in FIG. 2, a microcomputer (MC) 72, a transmitter circuit 73, a communication electrode 74 and a receiver circuit 75.

The transmitter circuit 73 is the same as a conventional signal transmitter circuit used in human body communication. The transmitter circuit 73 transmits, upon receiving a trigger signal from the microcomputer 72, the trigger signal to the vehicle-side human communicators 34, 42 and 52 through the communication electrode 24 and the body of the driver 5. Further, the transmitter circuit 73 transmits, upon receiving a data of a mobile unit ID (identification code) from the microcomputer 72, the mobile unit ID data to the vehicle-side human communicators 34, 42 and 52 through the communication electrode 74 and the body of the driver 5.

The communication electrode 74 is the same as a conventional communication electrode used for human body communication. Specifically, the communication electrode 74 of the vehicle-side human communicator 71 is provided on the mobile unit 70 to be contacted by the driver 5 through an insulator (not shown) when carried by the driver 5.

The receiver circuit 75 is the same as a conventional receiver circuit used for human body communication. When a data of a shift ID, a data of a brake ID and a data of a steering ID are transmitted from the vehicle-side human communicators 34, 42 and 52 by human body communication, the receiver circuit 75 receives such ID data through the communication electrode 74. The receiver circuit 75 sends the received data of the shift ID, the brake ID and the steering ID to the microcomputer 72. When the shift ID data, the brake ID data, and the steering ID data are transmitted from the vehicle-side human communicators 34, 42 and 52 at the same time, respectively, the receiver circuit 75 receives these ID data by superimposition. The superimposition of the ID data is described below in detail. The receiver circuit 75 sends the three kinds of ID data received and superimposed (superimposed received data) to the microcomputer 72.

According to the protocol of the human body communication in the embodiment, a predetermined space is provided in the transmission time point of each of the shift ID data, the brake ID data and the steering ID data from the vehicle-side human communicators 34, 42 and 52, respectively. The transmission time point of each of the shift ID data, the brake ID data and the steering ID data is determined so that each data part is in the space parts of other ID data. Specifically, the transmission time points of the shift ID data, the brake ID data and the steering ID data are determined in relation to the trigger signal as a reference time point so that each data part of one ID data may be superimposed in the space parts of the other two ID data. By thus transmitting the shift ID data, the brake ID data and the steering ID data, the superimposed received data received and superimposed by the mobile-side human communicator 71 and the receiver circuit 75 has no overlapping waveforms among the three data pulse signals. As a result, even when the mobile-side human communicator 71 receives a plurality of kinds of data in the superimposed form, each kind of data can be separated one another and processed easily by the microcomputer 72.

The data signal transmitted and received by human body communication is not limited to the pulse signal in the rectangular waveform. For example, the data signal transmitted and received may be any one of an analog signal or a digital signal and may also be a modulated signal of these data.

When the human body communication is established between the mobile-side human communicator 71 and the vehicle-side human communicator 34, 42 and 52, the microcomputer 72 sends a trigger signal to the transmitter circuit 73 and the transmitter circuit 73 responsively transmits the trigger signal to the vehicle-side communicators 34, 42 and 52.

When the microcomputer 72 receives the superimposed received data from the receiver circuit 75, the microcomputer 72 sends the mobile unit ID data of the mobile unit 7 and the transmitter circuit 73 responsively transmits the mobile unit ID data to the vehicle-side human communicators 34, 42 and 52. The mobile unit ID data is an identifier, which is specifically assigned to identify each mobile unit. If the data which the receiver circuit 75 receives is one of the three kinds of data (shift ID data, brake ID data and steering ID data) or superimposed two of the three kinds of data, the microcomputer 72 does not send the mobile unit ID data to the transmitter circuit 73. The microcomputer 72 extracts, based on the transmission time point determined by the communication protocol, the shift ID data, the brake ID data and the steering ID data from the data received from the receiver circuit 75. If the microcomputer 72 detects all the three kinds of ID data in the data received from the receiver circuit 75, it determines that all the three kinds of ID data are received by the mobile-side human communicator 71. The mobile unit ID of the mobile unit 70 is used as the identifier specific to the driver 5, if a holder of the mobile unit 70 is a specified driver. The mobile unit ID data is pre-stored in a memory of the microcomputer 72.

The microcomputer 72 need not necessarily be configured to detect whether all the three kinds of ID data are included in the data received from the receiver circuit 75 by extracting the shift ID data, the brake ID data and the steering ID data from the data received from the receiver circuit 75. As an alternative, for example, the microcomputer 72 may be configured to detect whether all the three kinds of ID data are included in the data received from the receiver circuit 75 by checking whether any data is present at a part corresponding to the transmission time points of the three kinds of ID data in the data received from the receiver circuit 75.

The vehicle-side human communicators 34, 42 and 52 are configured similarly one another. The vehicle-side human communicator 34 is shown in FIG. 3 as a representative example. The vehicle-side human communicator 34 includes a communication electrode 35, a receiver circuit 36, a microcomputer 37 and a transmitter circuit 38.

The communication electrode 35 is the same as a conventional communication electrode used for human body communication. Specifically, the communication electrode 35 of the vehicle-side human communicator 34 is provided on the grip portion of the shift lever 30 so that the driver 5 can touch the communication electrode 35 through the insulator when the driver 5 holds the shift lever 30.

The receiver circuit 36 is the same as a conventional receiver circuit used for human body communication. When the trigger signal is transmitted from the mobile-side human communicator 71 of the mobile unit 70 by the human body communication, the receiver circuit 36 receives the trigger signal through the communication electrode 35. When the mobile unit ID data is transmitted from the mobile-side human communicator 71 through the human body communication, the receiver circuit 36 receives the mobile unit ID data through the communication electrode 35.

When the receiver circuit 36 receives the trigger signal, the microcomputer 37 sends the shift ID data of the shift lever 30 to the transmitter circuit 38. The shift ID data is an identifier, which specifically indicates that it is from the vehicle-side human communicator 34 of the shift lever 30. The transmitter circuit 38 responsively transmits the shift ID data to the mobile-side human communicator 71 of the mobile unit 70 at a predetermined time point, which is a predetermined time later than the trigger signal as a reference time point. The transmission time point is determined by the communication protocol.

When the microcomputer 37 receives the mobile unit ID data, the microcomputer 37 sends the received mobile unit ID data to the automatic control ECU 10. The automatic control ECU 10 checks whether this mobile unit ID data is proper as described in detail below.

The transmitter circuit 38 is the same as a conventional receiver circuit used for human body communication. When the transmitter circuit 38 receives the shift ID data from the microcomputer 37, the transmitter circuit 37 transmits the received shift ID data to the mobile-side human communicator 71 through the communication electrode 35 and the body of the driver 5 in accordance with the instruction from the microcomputer 37 at a predetermined transmission time point.

The receiver circuit 36, the microcomputer 37 and the transmitter circuit 38 of the vehicle-side human communicator 34 may be provided within the shift lever 30, under a floor of the vehicle, within a steering wheel column or within an instrument panel, for example.

Similarly to the vehicle-side human communicator 34 of the shift lever 30 described with reference to FIG. 3, the vehicle-side human communicators 42 and 52 of the brake pedal 40 and the steering wheel 50 perform the human body communications, respectively. Specifically, although not shown, the vehicle-side human communicator 42 also includes a communication electrode, a receiver circuit, a microcomputer and a transmitter circuit, which operate in the similar manner as the communication electrode 35, the receiver circuit 36, the microcomputer 37 and the transmitter circuit 38, respectively. Further, the vehicle-side human communicator 52 includes a communication electrode, a receiver circuit, a microcomputer and a transmitter circuit, which operate in the similar manner as the communication electrode 35, the receiver circuit 36, the microcomputer 37 and the transmitter circuit 38, respectively.

Although the communication electrode 35 of the vehicle-side human communicator 34 of the shift lever 30 is provided on the grip part of the shift lever 30, the communication electrode of the vehicle-side human communicator of the brake pedal 40 is provided on a pedal part of the brake pedal 40 so that the driver 5 may contact or touch the electrode through an insulator when the driver places a foot on the pedal part to brake the vehicle. In addition, the communication electrode of the vehicle-side human communicator of the steering wheel 50 is provided on a grip part of the steering wheel 50 so that the driver 5 may contact or touch the electrode through an insulator when the driver holds the steering wheel 50 to steer the vehicle.

Although the vehicle-side human communicator 34 transmits the shift ID data toward the mobile-side human communicator 71 at the predetermined time point, the vehicle-side human communicator 42 transmits the brake ID data, which is an identifier indicating that it is originated from the vehicle-side human communicator 42 of the brake pedal 40, toward the mobile-side human communicator 71 at the predetermined time point. Further, the vehicle-side human communicator 52 transmits the steering ID data, which is an identifier indicating that it is originated from the vehicle-side human communicator 52 of the steering wheel 50, toward the mobile-side human communicator 71 at the predetermined time point. The shift ID data is pre-stored in a memory of the microcomputer 37 of the vehicle-side human communicator 34. The brake ID data and the steering ID data are also pre-stored in memories of microcomputers of the vehicle-side human communicators 42 and 52.

The human body communication performed through the human body of the driver 5 in the engine control system 100 is described with reference to FIG. 4.

It is assumed here that the driver 5 on a driver's seat is holding both the shift lever 30 and the steering wheel 50 and pressing down the brake pedal 40 as a preparatory manipulation before starting the engine. Although the shift lever 30 is provided on the floor of the vehicle in FIG. 4, the shift lever 30 may be provided on the instrument panel or on the steering wheel column.

If the driver 5 carries the mobile unit 70, the communication electrode 74 of the mobile-side human communicator 71 contacts the driver 5. If the driver 5 presses down the brake pedal 40, the communication electrode 45 of the vehicle-side human communicator 42 contacts the driver 5. If the driver 5 holds the shift lever 30, the communication electrode 35 of the vehicle-side human communicator 34 contacts the driver 5. If the driver 5 holds the steering wheel 50, the communication electrode 55 of the vehicle-side human communicator 52 contacts the driver 5. As a result, when the driver 5 holds the shift lever 30 and the steering wheel 50 and presses down the brake pedal 40, as the predetermined manipulation in preparation for starting the engine, the human body communication is established between the mobile-side human communicator 71 and the vehicle-side human communicators 34, 42 and 52 through the driver 5.

When the human body communication is established between the mobile-side human communicator 71 and the vehicle-side human communicators 34, 42 and 52, the trigger signal is transmitted from the mobile-side human communicator 71 to the vehicle-side human communicators 34, 42 and 52 by the human body communication. The vehicle-side human communicators 34, 42 and 52 transmit the shift ID data, the brake ID data and the steering ID data by the human body communication at respective transmission time points determined in accordance with the communication protocol in relation to the trigger signal as the reference. The shift ID data, the brake ID data and the steering ID data transmitted from the vehicle-side human communicators 34, 42 and 52 are superimposed and received by the mobile-side human communicator 71. When the mobile-side human communicator 71 receives the superimposed three kinds of ID data, the mobile-side human communicator 71 transmits its mobile unit ID data to the vehicle-side human communicators 34, 42 and 52 by the human body communication.

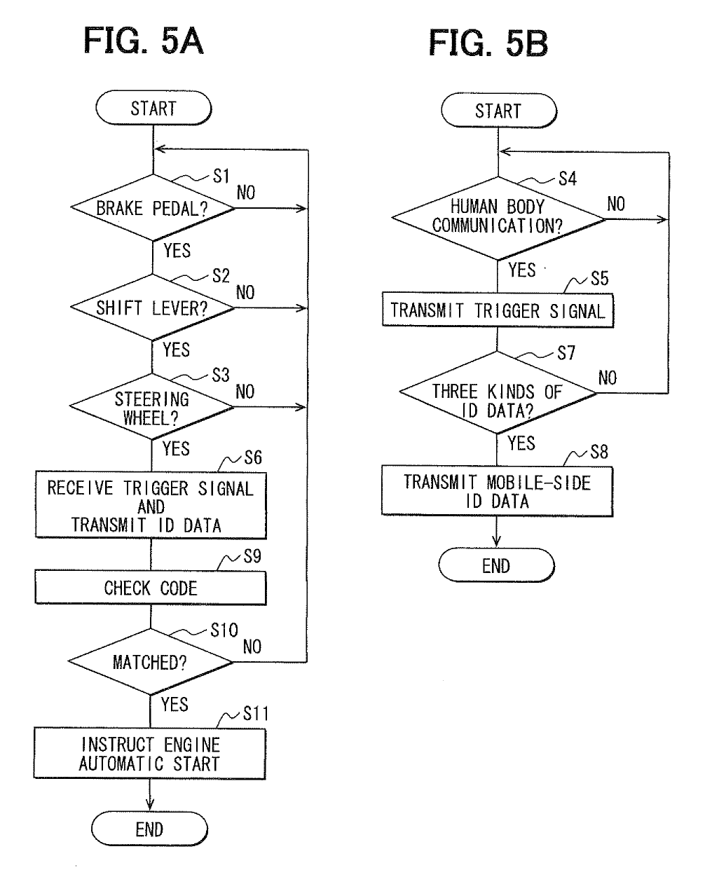

The engine automatic start processing performed in the engine control system 100 is exemplified in FIGS. 5A and 5B, which is performed by mostly the microcomputers of the automatic control ECU 10, the vehicle-side human communicators 34, 42, 52 and the mobile-side human communicator 71. This processing is started as long as the automatic engine switch 21 is in the turned-on state and the engine is not in operation.

The control ECU 10 first checks at S1 whether the brake pedal 40 is pressed down, based on a signal produced by the brake switch 41. If the control ECU 10 determines that the brake pedal 40 is pressed down (YES at S1), the control ECU 10 performs S2. If the control ECU 10 determines that the brake pedal 40 is not pressed down (NO at S1), the control ECU 10 repeats S1.

The control ECU 10 checks at S2 whether the shift lever 30 is held, based on a signal produced by the touch sensor 33 of the shift lever 30. If the control ECU 10 determines that the shift lever 30 is held (YES at S2), the control ECU 10 performs S3. If the control ECU 10 determines that the shift lever 30 is not held (NO at S2), the control ECU 10 repeats the processing from S1.

The control ECU 10 checks at S3 whether the steering wheel 50 is held, based on a signal produced by the touch sensor 51. If the control ECU 10 determines that the steering wheel 50 is held (YES at S3), the control ECU 10 performs S6. If the control ECU 10 determines that the steering wheel 50 is not held (NO at S3), the control ECU 10 repeats the processing from S1.

The mobile-side human communicator 71 checks at S4 whether the human body communication with any one of the vehicle-side human communicators 34, 42 and 52 is established. If the mobile-side human communicator 71 determines that the human body communication is established (YES at S4), the mobile-side human communicator 71 performs S5. If it is determined that the human body communication is not established (NO at S4), the mobile-side human communicator repeats 54.

The mobile-side human communicator 71 transmits a trigger signal by the human body communication at 55. One of the vehicle-side human communicators 34, 42 and 52, which received the trigger signal from the mobile-side human communicator 71, transmits vehicle-side ID data as a response signal in response to the trigger signal at S6. Specifically, when the vehicle-side human communicator 34 responds to the trigger signal, it transmits the shift ID data by the human body communication. When the vehicle-side human communicator 42 responds to the trigger signal, it transmits the brake ID data by the human body communication. When the vehicle-side human communicator 52 responds to the trigger signal, it transmits the steering ID data by the human body communication.

Then, the mobile-side human communicator 71, specifically its microcomputer 72, checks at S7 whether all the three kinds of ID data (shift ID data, brake ID data and steering ID data) are received. If the mobile-side human communicator 71 determines that all the three kinds of data are received (YES at S7), it performs S8. If the mobile-side human communicator 71 determines that none of or only a part of all the three kinds of data are received (NO at S7), the processing is repeated started from S4.

The mobile-side human communicator 71 transmits at S8 the mobile-side ID data by the human body communication toward the vehicle-side human communicators 34, 42 and 52.

The control ECU 10 performs code check at S9 based on the mobile-side ID data received by the vehicle-side human communicators 34, 42 and 52. In the code check step S9, the control ECU 10 compares the received mobile unit ID data with a predetermined ID data pre-stored in the ROM of the control ECU 10. The control ECU 10 determines that the received mobile unit ID data is proper if the received mobile unit ID data is in a predetermined relation to the stored predetermined ID data. The number of the predetermined data stored in the memory of the control ECU 10 may be one or more.

The code check at S9 is performed in respect of the mobile unit IDs received by the vehicle-side human communicators 34, 42 and 52. Alternatively, the code check at S9 may be performed in respect of only one of the mobile unit IDs received by the vehicle-side human communicators 34, 42 and 52.

The control ECU 10 checks at S10 whether the ID data compared at S9 match each other, that is, the mobile unit ID data is proper. If the ID data match (YES at S10), that is, the mobile unit ID data is proper, the control ECU 10 performs S1. If the ID data do not match (NO at S10), the processing is started from S1.

The control ECU 10 instructs at S11 an engine automatic start to engine ECU 60 at S11.

In this operation, the steps S4 to S10 are performed when all the check results at S1 to S3 are YES. However, the steps S1 to S3 may be performed, when the ID data matching is confirmed (YES) at S10 after performing S4 to S10. Steps S1 to S3 and steps S4 to S10 may be performed in parallel. The order of processing of S1 to S3 may be changed.

According to the embodiment, even if the predetermined manipulation in preparation for starting the engine (or probably for starting the engine), such as holding the shift lever 30, pressing down the brake pedal 40 and holding the steering wheel 50, is detected, the engine is not started automatically. The engine is started automatically only when the human body communication is established between the mobile unit 70 carried by the driver 5 and the shift lever 30, the brake pedal 40 and the steering wheel 50, which are manipulated for starting the engine, by the human body communication through the body of the driver 5. Therefore, even if any passenger carrying no mobile unit 70 accidentally manipulates any one of the shift lever 30, the brake pedal 40 and the steering wheel 50, the engine is not automatically started independently of the driver 5. As a result, the embodiment ensures the safety of the vehicle in a system that enhances the convenience of the driver 5 by allowing the automatic engine starting.

According to the embodiment, the engine is not started automatically, if the code check operation performed between the control ECU 10 and the mobile unit 70 indicates improper ID data. As a result, the engine is not started automatically by any person other than the driver 5 carrying the mobile unit 70 of the mobile unit ID, which corresponds to the pre-stored mobile ID data stored in the control ECU 10, even if such a person other than the driver 5 performs preparatory manipulation for starting the engine such as holding the shift lever 30, pressing down the brake pedal 40 or holding the steering wheel 50. Thus, not only the safety but also the security of the vehicle can be enhanced.

In the above embodiment, the transmission of the mobile unit ID data is not limited to the case, in which the mobile-side human communicator 71 receives the shift ID data, the brake ID data and the steering ID data in the superimposed manner. It is possible to transmit a request signal to the mobile-side human communicator 71 by the human body communication so that the mobile unit ID data is transmitted from the mobile-side human communicator 71 in response to the request signal, when any one of the vehicle-side human communicator 34, 42 and 52 receives the superimposed ID data including an ID data, which is not originated from itself. As an example, when the vehicle-side human communicator 34 receives the brake ID data and the steering ID data in the superimposed form, the vehicle-side human communicator 34 transmits a request signal by the human body communication and the mobile-side human communicator 71 transmits the mobile unit ID data. It may be checked whether the ID data is received in the superimposed form by the microcomputer of the vehicle-side human communicator in the same manner as the microcomputer 72.

Some of the conditions for starting the engine automatically are not limited to holding the shift lever 30, pressing down the brake pedal 40 and holding of the steering wheel 50 by the control ECU 10. For example, some of the conditions for starting the engine automatically may include only one or two of holding the shift lever 30, pressing down the brake pedal 40 and holding the steering wheel 50.

Further, some of the conditions for starting the engine automatically may include some or all of the turn-off of the ignition switch 23, closing of a driver's seat door from an open condition, the shift lever 30 in the P-range, a driver on the driver's seat, a seatbelt being buckled or tightened, manipulation on the shift-lock release button 31. The turn-off of the ignition switch 23 may be detected based on the signal of the ignition switch 23. The closing of the driver's seat door from open condition may be detected based on a signal of a courtesy switch of the driver's seat door. The P-range of the shift lever 30 may be detected based on a signal of the shift position sensor 32. The driver on the driver's seat may be detected by a signal of a seat sensor provided on the driver's seat. The buckling of the seatbelt may be detected based on a signal of a buckle switch of a driver's seatbelt. The manipulation on the shift-lock release button 31 may be detected by the shift-lock release button 31. The shift-lock release button 31 can be manipulated only when the brake pedal is being pressed down. Therefore, the detection of manipulation of the shift lock release button 31 indicates that the brake pedal 40 is being pressed down.

Although it is possible to select at least one of the foregoing manipulations as a part of precondition for automatically starting the engine, it is preferred to include as the precondition for automatically starting the engine at least two types of conditions of the embodiment, that is, pressing down the brake pedal 40 and holding the steering wheel 50.

The engine automatic starting condition need not include the establishment of the human body communication between the mobile unit 70 and all of the shift lever 30, the brake pedal 40 and the steering wheel 50. The engine automatic starting condition may include the establishment of the human body communication between the mobile unit 70 and any one of the shift lever 30, the brake pedal 40 and the steering wheel 50. According to this modification, even if any passenger carrying no mobile unit 70 erroneously manipulates any of the shift lever 30, the brake pedal 40 and the steering wheel 50, it is less likely that the engine will be automatically started against the intention of the driver 5.

Further, the establishment of the human body communication between the mobile unit 70 and the driver on the driver's seat may be included as a part of condition for automatically starting the engine. In this case, a vehicle-side human communicator, which is similar to the vehicle-side communicators 34, 42 and 52, may be provided on the driver's seat or a floor so that its communication electrode may contact the driver 5 through an insulator when the driver 5 places the body on the driver's seat.

Some of members having respective vehicle-side human communicators among members, which are manipulated in preparation for starting the engine, need not have sensors for detecting predetermined manipulations performed in preparation of the engine starting. For example, the shift lever 30 and the steering wheel 50 have no touch sensors, and only the pressing-down of the brake pedal 40 is detected as the predetermined manipulation for starting the engine. Holding of the shift lever 30 and holding the steering wheel 50 may be indirectly detected by the establishment of the human body communication of the mobile unit 70 with the shift lever 30 and the steering wheel 50. Pressing down the brake pedal 40 need be detected by the brake switch 41, because it cannot be detected based on the establishment of the human body communication between the mobile unit 70 and the brake pedal 40. Thus, by the use of the human body communication in detecting the predetermined manipulation in preparation for starting the engine, work and costs for mounting such detection sensors can be reduced.

The embodiment maybe modified to automatically stop the engine.

For example, the control ECU 10 is configured to automatically stop the engine by detecting a predetermined manipulation performed for stopping the engine and confirming establishment of the human body communication between the mobile unit 70 and an one of in-vehicle devices manipulated in preparation for stopping the engine. Preconditions for automatically stopping the engine may include any one of resting (not traveling) of the vehicle, shift lever 30 at the P-range, pressing-down of the brake pedal 40, an air-conditioner switch in a turned-off state, unbuckling of the seatbelt and application of parking brake (hand brake). The resting of the vehicle may be detected by a travel speed sensor and an engine rotation sensor. The turned-off state of the air-conditioner switch may be detected by the air-conditioner switch. The unbuckling of the seatbelt may be detected by a buckle switch of the seatbelt. The application of the parking brake may be detected by a parking brake switch. It is also possible to include as the precondition for automatically stopping the engine that the human body communication is established between the mobile unit 70 and at least one of the brake pedal 70 and the parking brake. In this instance, a vehicle-side human communicator is provided on the parking brake in the similar manner as the vehicle-side human communicators 34, 42 and 52. A communication electrode of the human communicator is provided on a grip part of the parking brake so that it may be touched or contacted by the driver 5 through an insulator when the driver manipulates a parking brake device.

Even when the predetermined manipulation for stopping the engine (or manipulation considered with high possibility to be performed for stopping the engine) is detected, the engine is not automatically stopped if the human body communication is not established through the driver 5 between the mobile unit 70 carried by the driver 5 and any one of in-vehicle devices manipulated in preparation for stopping the engine. As a result, even when a passenger carrying no mobile unit 70 accidentally manipulates such in-vehicle devices, the engine is not automatically stopped against the intention of the driver 5.

The embodiment may be further modified to realize the engine automatic start operation in a vehicle having a manual transmission. In this modification, the predetermined manipulation in preparation for starting the engine may include at least one of pressing-down of the brake pedal 40, pressing-down of a clutch pedal, buckling a seatbelt with a shift lever of the manual transmission in a neutral position (N-range), seating on the driver's seat with the shift lever of the manual transmission in the neutral position (N-range), shifting the shift lever from the neutral position to a drive position (D-range or R-range), and holding the steering wheel. The pressing-down of the clutch pedal may be detected by a clutch switch. The buckling of the seatbelt with the shift lever in the neutral position may be detected by a buckle switch and a shift position sensor. The seating on the driver's seat with the shift lever in the neutral position may be detected by a seat sensor provided on the driver's seat and the shift position sensor. The shifting of the shift lever from the neutral position to the drive position (D-ranger R-range and the like) may be detected by the shift position sensor.

It is also possible to include as the precondition for automatically starting the engine that the human body communication is established between the mobile unit 70 and at least one of the shift lever 30, the brake pedal 40, the steering wheel 50, the clutch pedal and the driver's seat. In this instance, a vehicle-side human communicator is provided on the clutch pedal and the driver's seat in the similar manner as the vehicle-side human communicators 34, 42 and 52. A communication electrode of the human communicator is provided on a pedal part of the clutch pedal so that it may be touched or contacted by the driver 5 through an insulator when the driver 5 presses down the clutch pedal.

In the embodiment, the code check operation between the control ECU 10 and the mobile unit 70 may be performed by any means other than the human body communication. For example, the mobile unit 70 may be equipped with a transponder and an antenna so that the mobile unit ID data is transmitted by radio communications to a tuner connected to the control ECU 10. The control ECU 10 checks the mobile unit ID data received by the tuner.

The code check operation between the control ECU 10 and the mobile unit 70 need not necessarily be performed.

It is preferred that, in addition to the automatic starting and/or stopping the engine, the system is so configured that the engine may be started and/or stopped manually in the conventional manner by turning a rotary member of the ignition switch to the accessory position, ignition-on position and the start position or by turning the same to the off position. Further, the engine may be started or stopped by turning on and off a push button-type engine switch.

Only one of the starting and the stopping of the engine may be performed automatically. For example, if the system is configured such that the engine is also started or stopped manually by turning on and off the push button-type engine switch, the engine may be started manually by turning on the push button-type engine switch by the driver and the engine may be stopped automatically in the manner described above. Alternatively, the engine may be started automatically, and the engine may be stopped manually by turning off the push button-type engine switch by the driver. In this instance, the ignition switch device 20 need not be provided.

In the present invention exemplified as the embodiment and modifications, stopping the engine includes stopping the engine from rotating or changing the power supply condition in the vehicle from the ignition-on condition to the ignition-off condition, that is, turning-off of the electric power supply to the engine ECU 60. Further, starting the engine includes, for example, starting the engine to rotate or turning on the power supply to the engine ECU 60.

The control ECU 10 and the engine ECU 60 may be integrated into one unit or may be provided separately.

According to the present invention, the human body communication is used in the control of engine automatic starting and engine automatic stopping, secrecy can be assured more highly than in checking a code by radio communication. Further, the engine can be automatically started and stopped while ensuring the safety of the vehicle by simply performing the predetermined manipulation in preparation for the engine starting by the driver 5 carrying the mobile unit 70. Thus, the driver 5 can enjoy higher comfort in the engine control system 100 relative to other vehicles.

The present invention should not be limited to the embodiment and the modifications, and may be implemented in a variety of ways.

What is claimed is:

1. An engine control system for a vehicle having an engine comprising:
a mobile unit carried by a driver and including a mobile-side human communicator for transmitting and receiving data by human body communication using a body of the driver;
a start-time manipulation device corresponding to at least one of members manipulated by the driver in a predetermined manipulation, which is normally performed by the driver to start the vehicle from a parked condition but not exclusive to starting the engine of the vehicle, the start time manipulation device including a vehicle-side human communicator for transmitting and receiving data by the human body communication;
a start manipulation detection part configured to detect the predetermined manipulation;
an operation check part configured to check whether the predetermined manipulation is detected by the start manipulation detection part, and check whether data is transmitted and received between the mobile unit and the start-time manipulation device by the human body communication; and
a start control part configured to automatically start the engine based on an operation check result of the operation check part indicating detection of the predetermined manipulation and data communication between the mobile unit and the start-time manipulation device by the human body communication.

2. The engine control system according to claim 1, further comprising:
a code check part configured to check a code of the mobile unit when the operation check result of the operation check part indicates the detection of the predetermined manipulation and the data communication between the mobile unit and the start-time manipulation device by the human body communication,
wherein the start control part is configured to automatically start the engine only on condition that a code check result of the code check part indicates the code is proper.

3. The engine control system according to claim 1, wherein:
the start-time manipulation device includes at least one of a shift lever, a brake pedal, a steering wheel and a driver's seat; and
the start manipulation detection part is configured to detect, as the predetermined manipulation, at least one of holding of the shift lever of an automatic transmission, pressing-down of the brake pedal, holding the steering wheel, buckling a seatbelt, and seating on a driver's seat.

4. The engine control system according to claim 1, wherein:
the start-time manipulation device includes at least one of a shift lever, brake pedal, a steering wheel, a clutch pedal and a driver's seat; and
the start manipulation detection part is configured to detect, as the predetermined manipulation, at least one of shifting the shift lever of the manual transmission from a neutral position to a drive position, pressing down the brake pedal, holding the steering wheel, pressing down the clutch pedal of the manual transmission, seating on a driver's seat with the shift lever of the manual transmission in the neutral position, and buckling a seatbelt with the shift lever of the manual transmission in the neutral position.

5. An engine control system for a vehicle having an engine comprising:
a mobile unit carried by a driver and including a mobile-side human communicator for transmitting and receiving data by human body communication using a body of the driver;
a stop-time manipulation device corresponding to at least one of members manipulated by the driver in a predetermined manipulation, which is normally performed by the driver to park the vehicle from a rest condition with the engine in operation but not exclusive to stopping the engine, the stop-time manipulation device including a vehicle-side human communicator for transmitting and receiving data by the human body communication;
a stop manipulation detection part configured to detect the predetermined manipulation;
an operation check part configured to check whether the predetermined manipulation is detected by the stop manipulation detection part, and check whether data is transmitted and received between the mobile unit and the stop-time manipulation device by the human body communication; and
a stop control part configured to automatically stop the engine based on an operation check result of the operation check part indicating detection of the predetermined manipulation and data communication between the mobile unit and the stop-time manipulation device by the human body communication.
